(19) United States
(12) Patent Application Publication
(10) Pub. No.: US 2002/0007651 A1
(43) Pub. Date: Jan. 24, 2002

(54) Method of manufacturing an optical head

(76) Inventors: Manami Kuiseko, Kyoto-shi (JP); Yasushi Kobayashi, Itami-shi (JP)

Correspondence Address: Barry E. Bretschneider, Morrison & Foerster LLP, Suite 5500, 2000 Pennsylvania Avenue, N.W., Washington, DC, 20006-1888, US

(21) Appl. No.: 09/855,844

(22) Filed: May 16, 2001

(30) Foreign Application Priority Data
May 16, 2000 (JP) 2000-143199

(51) Int. Cl. C03C 27/00

(52) U.S. Cl. 65/23; 65/37; 204/157.41

(57) ABSTRACT

A method of manufacturing an optical head having a near-filed light generating element that condenses a luminous flux on an exit surface. The generating element has a reflecting or light intercepting film formed on the exit surface and is fixed to a holding member to form an optical head. A minute opening is then formed in the reflecting or light intercepting film by use of light emitted from a first or second light source.

### RELATED APPLICATION

This application is based on application No. 2000-143199 filed in Japan, the content of which is hereby incorporated by reference.

1. Technical Field of the Invention

The present invention relates to a method of manufacturing an optical head, and more particularly, to a method of manufacturing an optical head having a near-field light generating element that condenses a luminous flux on an exit surface.

2. Background of the Invention

In recent years, with the increase in optical recording, high-density optical recording using near-field light has been researched and developed. For an optical head that generates near-field light to perform recording or reproduction, it is examined to use an optical element called a solid immersion lens or a solid immersion mirror. The optical element is fitted in a holding member, such as a slider, and floated in a position several tens of nanometers away from the recording medium. The condensed light beam is emitted as near-field light from a minute spot, thereby performing recording or reproduction.

It is known that in this kind of near-field light generating element, resolving power is improved by forming a minute opening in the exit surface to cut propagating light.

Conventionally, to form a minute opening in the near-field light generating element, during the element unit manufacturing process, a light intercepting film is formed on the exit surface of the element. A laser beam is then applied to the light intercepting film to form the minute opening. Thereafter, the element having the minute opening is fixed to a holding member constituting the optical head.

However, according to the conventional manufacturing method, since an error of the minute opening formed position or an error of assembly caused when the element is fitted into the holding member cannot be avoided, the actual imaging point is shifted from the minute opening, so that near-field light is not emitted. Although making an adjustment to situate the minute opening at the actual imaging point when the element is fitted into the holding member has been considered, such an adjustment is extremely complicated and impractical.

### SUMMARY OF THE INVENTION

Accordingly, the present invention provides a method of manufacturing an optical head by which the minute opening can be formed in an accurate position of the exit surface of the element and near field light is emitted out with reliability.

The method includes, for example, a near-field light generating element that condenses a luminous flux on an exit surface, wherein a near-field light generating element having a reflecting film or a light intercepting film formed on the exit surface is fixed to a holding member to form an optical head. A minute opening is then formed in the reflecting film or the light intercepting film by use of light emitted from a first light source for recording or reproduction, or a second light source disposed in a position being conjugate with the first light source.

### BRIEF DESCRIPTION OF THE DRAWINGS

This and other and features of the invention will become clear from the following description, taken in conjunction with the preferred embodiments with reference to the accompanied drawings in which:

FIG. 1 is a cross-sectional view showing a first example of the near-field light generating element used by the manufacturing method of the present invention;

FIG. 2 is a cross-sectional view showing a second example of the near-field light generating element used by the manufacturing method of the present invention;

FIG. 3 is a cross-sectional view showing a third example of the near-field light generating element used by the manufacturing method of the present invention;

FIG. 4 is a cross-sectional view showing a fourth example of the near-field light generating element used by the manufacturing method of the present invention;

FIG. 5 is a cross-sectional view showing a fifth example of the near-field light generating element used by the manufacturing method of the present invention;

FIG. 6 is a cross-sectional view showing an example forming a minute opening as an embodiment of the present invention;

FIG. 7 is a cross-sectional view showing an example of the film structure of the near-field light generating element;

FIG. 8 is a cross-sectional view showing another example of the film structure of the near-field light generating element; and

FIG. 9 is a graph showing a temperature-sensitivity characteristic of a super-resolution film in the film structure shown in FIG. 8.

### DETAILED DESCRIPTION OF THE INVENTION

According to one embodiment, in a method of manufacturing an optical head having a near-field light generating element that condenses a luminous flux on an exit surface, a near-field light generating element having a reflecting film or a light intercepting film formed on the exit surface is fixed to a holding member to form an optical head. A minute opening is then formed in the reflecting film or the light intercepting film by use of light emitted from a first light source for recording or reproduction, or a second light source disposed in a position being conjugate with the first light source.

According to the manufacturing method of the present invention, the minute opening is formed in the reflecting film or the light intercepting film provided on the exit surface of the element by use of light emitted from the first light source for recording or reproduction, or the second light source disposed in a position being conjugate with the first light source. As a result, the formed position error or the assembly error caused in the element unit manufacturing process, which error is a problem in the conventional method, is not caused. Hence, the minute opening is formed at the actual imaging point with reliability. As a result, an optical head where near-field light is emitted out with reliability is obtained. Needless to say, a complicated adjustment for situating the minute opening at the actual imaging point is completely unnecessary when the optical head is assembled.

In the manufacturing method according to the present invention, it is preferable that the light emitted from the second light source be higher in energy than the light emitted from the first light source. It is also preferable that the minute opening be formed by vaporizing the reflecting film or the light intercepting film with the energy at the light condensation point. The minute opening can efficiently be formed by high-energy light.

The light emitted from the second light source may be shorter in wavelength than that emitted from the first light source, and the minute opening is formed by vaporizing the reflecting film or the light intercepting film by the energy at the light condensation point. A minute opening can be formed, so that resolving power improves. In this case, however, it is necessary for the near-field light generating element to condense a luminous flux on the exit surface only by reflection. This is because when condensed only by reflection, even light of a different wavelength is condensed without any aberration.

It is preferable that the near-field light generating element according to the present invention be structured so that parallel light is incident on a first surface (being a plane surface) and is reflected at a second surface (being substantially a paraboloid of revolution). The near-field light generating element can easily be manufactured because it can be formed of a plane surface and another surface.

The near-field light generating element may be structured so that diffused light is incident on a first surface, being a concave surface, and is reflected at a second surface, being substantially a paraboloid of revolution. A collimator lens for directing light from the light source to the near-field light generating element can be reduced in size, and aberrations can easily be reduced because the collimator lens uses a weak optical power.

The near-field light generating element may be structured so that parallel light is incident on a first surface, being a convex surface, and is reflected at a second surface, being substantially a paraboloid of revolution. Since the first surface is a convex surface, off-axial performance increases, so that an optical system that is tolerant of decentering errors is obtained.

The near-field light generating element may be structured so that converged light is incident on a first surface, being a convex surface, and is reflected at a second surface, being substantially a paraboloid of revolution. Since the light is not refracted at the first surface, not only can a light source of a different wavelength be used, but also an optical system that is tolerant of decentering errors is obtained.

The near-field light generating element may be structured so that parallel light is incident on a first surface (being a plane surface), is divergently reflected at a second surface (being one of two parts into which a paraboloid of revolution is cut), and is reflected at a third surface (being one of two parts into which a spheroid is cut), to be imaged. Since the luminous flux is diverged at the second surface, an optical system with a large numerical aperture can be formed.

The near-field light generating element may be structured so that parallel light is incident on a first surface (being a plane surface) and is convergently reflected at a second surface (being one of two parts into which a paraboloid of revolution is cut), to be imaged. Since only one reflecting surface is necessary, the near-field light generating element is easily manufactured.

In the manufacturing method according to the present invention, it is preferable that the reflecting film or the light intercepting film be provided on a super-resolution film provided on the exit surface of the element. Since the super-resolution film abruptly increases in sensitivity at temperatures not less than a predetermined temperature, a smaller opening can be formed.

The reflecting film or the light intercepting film may be provided on a film with high heat-absorbing capability provided on the exit surface of the element. Since the necessary temperature can be reached with a small amount of energy, the minute opening can quickly be formed.

The embodiment of the method of manufacturing an optical head according to the present invention will be described in more detail with reference to the attached drawings.

Modes of the Near-Field Light Generating Element

First, several modes of the near-field light generating element incorporated in an optical head manufactured by the manufacturing method according to the present invention will be described.

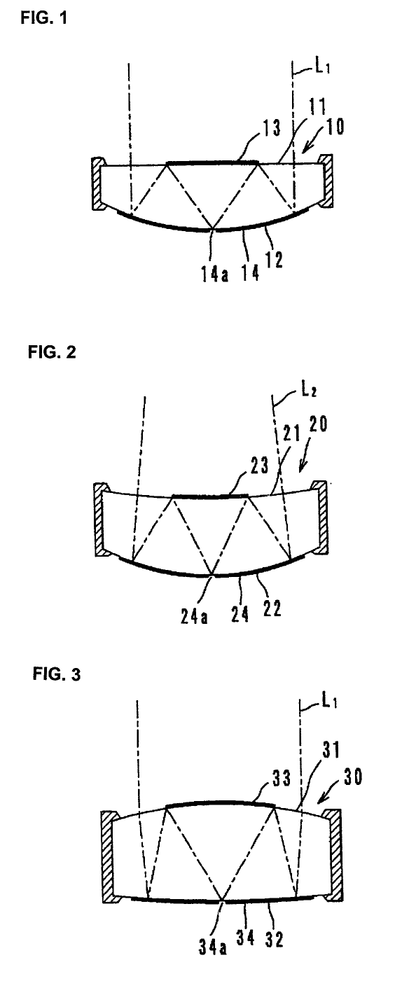

FIG. 1 shows a solid immersion mirror 10 as a first example. The solid immersion mirror 10 is made of a high-refractive-index material (for example, lanthanum silica glass or lead silica glass), and reflecting films 13 and 14 are provided on a central part of a first surface 11 and substantially on the entire area of a second surface 12. First surface 11 is a plane surface and second surface 12 is a paraboloid of revolution. In the reflecting film 14, a minute opening 14a is formed at the imaging point of a laser beam L1.

The reflecting films 13 and 14 are formed by a known thin film technology, such as sputtering, by use of a metallic material such as Al, Au, Ag, Cu or Ni. The minute opening 14a is formed by vaporizing the reflecting film 14 with heat caused by application of the laser beam L1 as described below.

In second to fifth examples described below, the high-refractive-index material and the formation method of the reflecting film (the light intercepting film) are similar to those of the first example.

In the solid immersion mirror 10, the laser beam L1 (being parallel light) is incident on the first surface 11, is reflected at the second surface 12, and is reflected at the central part of the first surface 11 to be imaged on a central part of the second surface 12, that is, at the minute opening 14a.

FIG. 2 shows a solid immersion mirror 20 as the second example. The solid immersion mirror 20 is made of a high-refractive-index material, and reflecting films 23 and 24 are provided on a central part of a first surface 21 (being a concave surface) and substantially on the entire area of a second surface 22 (being a paraboloid of revolution), respectively. In the reflecting film 24, a minute opening 24a is formed at the imaging point of a laser beam L2.

In the solid immersion mirror 20, the laser beam L2 (being diffused light) is incident on the first surface 21, is reflected at the second surface 22, and is reflected at the central part of the first surface 21 to be imaged on a central part of the second surface 22, that is, at the minute opening 24a.

FIG. 3 shows a solid immersion mirror 30 as the third example. The solid immersion mirror 30 is made of a high-refractive-index material, and reflecting films 33 and 34 are provided on a central part of a first surface 31 (being a convex surface) and substantially on the entire area of a second surface 32 (being a paraboloid of revolution), respectively. In the reflecting film 34, a minute opening 34a is formed at the imaging point of a laser beam L1.

In the solid immersion mirror 30, the laser beam L1 (being parallel light) is incident on the first surface 31 to be refracted, is reflected at the second surface 32, and is reflected at the central part of the first surface 31 to be imaged on a central part of the second surface 32, that is, at the minute opening 34a.

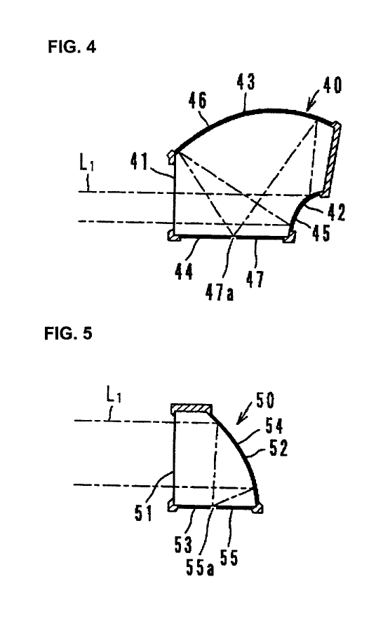

FIG. 4 shows a solid immersion mirror 40 as the fourth example. The solid immersion mirror 40 is made of a high-refractive-index material, and includes a first surface 41 being a plane surface; a second surface 42 being a diverging surface that is one of two parts, into which a paraboloid of revolution is cut along the optical axis; a third surface 43 being a condensing surface, that is one of two parts into which a paraboloid of revolution (having one focal point at the focal point of the second surface 42) is cut along the optical axis; and a fourth surface 44 (being a plane surface) including the other focal point of the third surface 43.

Reflecting films 45 and 46 and a light intercepting film 47 are provided substantially on the entire areas of the second surface 42, the third surface 43 and the fourth surface 44, respectively. In the light intercepting film 47, a minute opening 47a is formed at the imaging point of a laser beam L1.

In the solid immersion mirror 40, the laser beam L1 (being parallel light) is incident on the first surface 41, is reflected at the second surface 42 and the third surface 43, and is imaged on a central part of the fourth surface 44, that is, at the minute opening 47a.

FIG. 5 shows a solid immersion mirror 50 as the fifth example. The solid immersion mirror 50 is made of a high-refractive-index material, and includes a first surface 51 being a plane surface; a second surface 52 being a condensing surface, that is one of two parts into which a paraboloid of revolution is cut along the optical axis; and a third surface 53 being a plane surface including the focal point of the second surface 52.

A reflecting film 54 and a light intercepting film 55 are provided substantially on the entire areas of the second surface 52 and the third surface 53, respectively. In the light intercepting film 55, a minute opening 55a is formed at the imaging point of a laser beam L1.

In the solid immersion mirror 50, the laser beam L1 (being parallel light) is incident on the first surface 51, is reflected at the second surface 52, and is imaged on a central part of the third surface 53, that is, at the minute opening 55a.

Formation of the Minute Opening

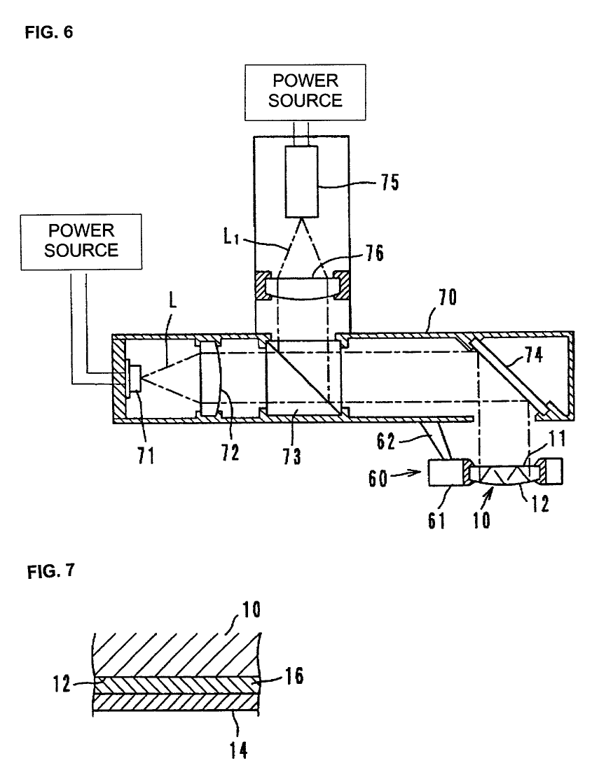

A method of forming the minute opening in the reflecting film or the light intercepting film of the near-field light generating element will be described with reference to FIG. 6. While the method will be described with respect to the solid immersion mirror 10, a similar method is used for the solid immersion mirrors 20, 30, 40 and 50 and non-illustrated other solid immersion mirrors of the same kind and solid immersion lenses.

The solid immersion mirror 10 with the reflecting films 13 and 14 formed thereon is held at its periphery by a slider 61 constituting an optical head 60. The slider 61 is supported by a lens barrel 70 through a suspension 62. The lens barrel 70 is provided with a laser diode 71 used as a light source for recording or reproduction, a collimator lens 72, a beam splitter 73 comprising a combination of two prisms, and a plane mirror 74.

The lens barrel 70 is further provided with a laser diode 75 for minute opening formation and a collimator lens 76. The laser diode 75 is disposed in a position being conjugate with the laser diode 71.

The laser beam L1 emitted from the laser diode 75 is collimated by the collimator lens 76, is perpendicularly deflected by the beam splitter 73, and is reflected at the plane mirror 74 to be incident on the first surface 11 of the solid immersion mirror 10. The laser beam L1 incident on the solid immersion mirror 10 is condensed on the central part of the second surface 12 (as described above) to heat the reflecting film 14, thereby forming the minute opening 14a.

During recording or reproduction, a laser beam L emitted from the laser diode 71 is collimated by the collimator lens 72, passes through the beam splitter 73, and is reflected at the plane mirror 74 to be incident on the first surface 11 of the solid immersion mirror 10. The laser beam L incident on the solid immersion mirror 10 is condensed on the central part of the second surface 12 as described above, and emits as near-field light from the minute opening 14a.

The laser diode 75 is used for forming the minute opening 14a, and is detached from the lens barrel 70 together with the collimator lens 76, after the minute opening 14a is formed. The beam splitter 73 may be detached as well.

As described above, by forming the minute opening 14a with the solid immersion mirror 10, the minute opening 14a is formed in an extremely accurate position. Hence, complicated adjustment such as a position adjustment is unnecessary. Specifically, immersion mirror 10 is fixed to the slider (holding member) 61 by use of the laser beam L1 emitted from the laser diode 75, s which is disposed in a position conjugate with the laser diode 71 used for recording or reproduction.

The minute opening 14a may be formed by use of the laser diode 71 for recording or reproduction without the use of the laser diode 75. However, when the laser diode 75 is used, the minute opening 14a can be formed by vaporizing the reflecting film 14 with a laser beam of higher energy and/or a laser beam of a shorter wavelength than the laser beam emitted from the laser diode 71.

As the high-power light source, a YAG laser, for example, is used. By using a high-power light source, the minute opening 14a can efficiently be formed.

As the short-wavelength light source, a KrF laser or a mercury lamp, for example, is used. By using a laser beam of a shorter wavelength than the laser beam emitted from the light source for recording or reproduction, a smaller opening 14a can be formed, so that resolving power improves.

To efficiently vaporize the reflecting film 14 in forming the minute opening 14a, as shown in FIG. 7, a film 16 with high heat-absorbing capability may be formed on the second surface 12 of the solid immersion mirror 10, and the reflecting film 14 is formed on the film 16. Examples of the material for the film with high heat-absorbing capability includes carbon.

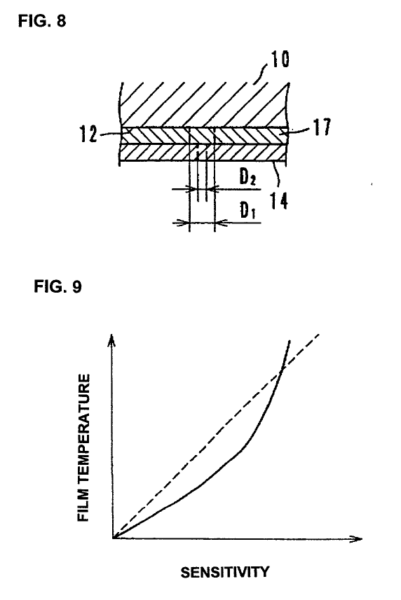

To form a smaller opening 14a, as shown in FIG. 8, a super-resolution film 17 may be formed on the second surface 12 of the solid immersion mirror 10, and the reflecting film 14 is formed on the film 17. The super-resolution film is a thin film where the diameter D2 of the beam exiting from the film is smaller than the diameter D1 of the beam incident on the film. Photochromic materials and thermochromic materials have such a characteristic. Concrete examples include antimony. The super-resolution film abruptly increases in sensitivity at temperatures not less than a predetermined temperature as shown in FIG. 9, so that a smaller opening 14a can be formed.

Other Embodiments

The method of manufacturing an optical head according to the present invention is not limited to the above-described embodiment but may variously be changed or modified within the scope of the invention.

Particularly, as the near-field light generating element, a solid immersion lens may be used as well as the solid immersion mirror, and the configuration thereof is arbitrary. The structure for fixing the element to the holding member and the structure of the optical path are also arbitrary.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A method of manufacturing an optical head having a near-field light generating element that condenses a luminous flux on an exit surface, comprising:
fixing the near-field light generating element, having a film formed on the exit surface, to a holding member to form an optical head; and
forming an opening in the film by use of light emitted from at least one of a first light source and a second light source, the second light source disposed in a position conjugate with the first light source.

2. The method of claim 1, wherein the film is a reflecting film or a light intercepting film.

3. The method of claim 1, wherein the first light source and the second light source have the same focusing point.

4. The method of claim 1, wherein light emitted from the second light source has a shorter wavelength than light emitted from the first light source.

5. The method of claim 4, wherein the opening is formed by vaporizing the film using energy generated at the point of the condensed luminous flux.

6. The method of claim 1, wherein the generating element is a solid immersion mirror or a solid immersion lens.

7. The method of claim 6, wherein the solid immersion mirror comprises:
a first surface of the mirror; and
a second surface of the mirror, a first portion of the film being provided on a central part of the first surface and a second portion of the film being provided on substantially an entire area of the second surface.

8. The method of claim 7, wherein the first surface is concave and the second surface is paraboloid of revolution.

9. The method of claim 7, wherein the first surface is planar and the second surface is a parabaloid of revolution.

10. The method of claim 7, wherein the first surface is convex and the second surface is a paraboloid of revolution.

11. The method of claim 6, wherein the solid immersion mirror comprises:
a first surface which is plane surface;
a second surface which is a diverging surface having a first and second part into which a paraboloid is cut along an optical axis;
a third surface which is a condensing surface having a third and fourth part into which a paraboloid is cut along an optical axis; and
a fourth surface which is a plane surface and includes a focal point of the third surface.

12. The method of claim 11, further comprising:
providing the film on substantially an entire surface of the second, third and fourth surfaces;
emitting the light incident on the first surface; and
reflecting the light on the second surface and the third surface, and imaging the light on a central part of the fourth surface.

13. The method of claim 6, wherein the solid immersion mirror comprises:
a first surface which is a plane surface;
a second surface which is a condensing surface having two parts into which a paraboloid of revolution is cut along an optical axis; and
a third surface which is a plane surface including a focal point of the second surface.

14. The method of claim 13, further comprising:
providing the film substantially on an entire surface area of the second a third surfaces;
emitting the light incident on the first surface; and
reflecting the light on the second surface, and imaging the light on a central part of the third surface.

15. The method of claim 7, further comprising:
emitting the light incident on a first surface of the solid immersion mirror; and
reflecting the light on a second surface of the solid immersion mirror at a central portion of the first surface to be imaged on a central portion of the second surface at the opening.

16. A method of forming an opening using a near-field light generating element, comprising:
forming a super-resolution film on an exit surface of the element and a reflective film on the super-resolution film; and
forming an opening in the reflective film by use of a beam emitted from at least one of a first light source and a second light source,
the second light source disposed in a position conjugate with the first light source.

17. The method of claim 16, wherein the super-resolution film is a thin film having a diameter of the beam exiting from the super-resolution film smaller than the diameter of the beam incident of the super-resolution film.

18. The method of claim 17, wherein the element is a solid immersion mirror or a solid immersion lens.

19. A method of forming an opening using a near-field light generating element, comprising:
forming a high heat-absorbing film on an exit surface of the element and a reflective film on the high heat-absorbing film; and
forming an opening in the reflective film by use of a beam emitted from at least one of a first light source and a second light source,
the second light source disposed in a position conjugate with the first light source.
